(19) United States
(12) Patent Application Publication
(10) Pub. No.: US 2016/0118761 A1
(43) Pub. Date: Apr. 28, 2016

(54) LASER OSCILLATOR FOR IMPROVING BEAM QUALITY

(71) Applicant: FANUC CORPORATION, Minamitsuru-gun (JP)

(72) Inventors: Yoshiaki Suizu, Yamanashi (JP); Tetsuhisa Takazane, Minamitsuru-gun (JP)

(73) Assignee: FANUC CORPORATION, Minamitsuru-gun (JP)

(21) Appl. No.: 14/919,181

(22) Filed: Oct. 21, 2015

(30) Foreign Application Priority Data
Oct. 22, 2014 (JP) 2014-215665

(51) Int. Cl. H01S 3/03; H01S 3/223

(52) U.S. Cl. CPC H01S 3/0305; H01S 3/2232

(57) ABSTRACT

An output coupler and a rear mirror of a laser oscillator are made of materials having first reflectance and second reflectance with respect to laser beam. A first coating material that has reflectance higher than the first reflectance is coated at an inner side of a first circle of a first surface of the output coupler, and no coating material is coated at an outer side of the first circle. A second coating material that has reflectance higher than the second reflectance and higher than that of the first coating material is coated at an inner side of a second circle of a first surface of the rear mirror, and no coating material is coated at an outer side of the second circle.

### TECHNICAL FIELD

The present invention relates to a laser oscillator that excites laser gas by a discharge tube to oscillate a laser beam.

### BACKGROUND ART

In general, the quality (light focusing property) of laser beam output from a laser oscillator is improved as a mode order is lowered. In this regard, there has been known a laser oscillator that is configured to restrain laser oscillation of a high order mode and to allow laser oscillation to occur in a low order mode (for example, refer to Patent Registration No. 3313623, Japanese Laid-open Patent Publication No. 2013-247260, and Japanese Laid-open Patent Publication No. 2009-94161). In the laser oscillators disclosed in Patent Registration No. 3313623, Japanese Laid-open Patent Publication No. 2013-247260, Japanese Laid-open Patent Publication No. 2009-94161 and the like, an aperture is arranged between an output coupler and a rear mirror and the diameter of laser beam is limited by the aperture, so that laser oscillation of a high order mode is restrained.

However, since the laser oscillators, which are disclosed in Patent Registration No. 3313623, Japanese Laid-open Patent Publication No. 2013-247260, Japanese Laid-open Patent Publication No. 2009-94161 and the like, have an aperture, the laser oscillators have problems in which a configuration is complicated and the aperture absorbs laser beam, resulting in the reduction of laser output. In contrast, there has been known a laser oscillator that is configured to perform two types of coating with different reflectances on the surfaces of an output coupler and a rear mirror to oscillate only laser beam of a low order mode (for example, refer to Japanese Laid-open Patent Publication No. 2-166778). In the laser oscillator that is disclosed in Japanese Laid-open Patent Publication No. 2-166778, a semi-transmissive film is coated on a radial center portion of the output coupler and a non-reflective film is coated at a peripheral portion thereof. Alternatively, total reflection coating is performed on a radial center portion of the rear mirror and non-reflective coating is performed at a peripheral portion thereof.

However, in the laser oscillator that is disclosed in Japanese Laid-open Patent Publication No. 2-166778, since two types of coating with different reflectances is performed on the surfaces of the output coupler and the rear mirror, a manufacturing process is complicated.

### SUMMARY OF INVENTION

According to a first aspect of the present invention, a laser oscillator comprises:

a discharge tube having a discharge area in which laser gas is excited; and

an output coupler and a rear mirror respectively arranged at both sides of the discharge tube,

wherein the output coupler and the rear mirror are made of materials having first reflectance and second reflectance with respect to laser beam,

a first coating material that has reflectance higher than the first reflectance is coated at an inner side of a first circle of a surface of the output coupler facing the discharge area, the first circle corresponding to 90% or more and 100% or less of an inner diameter of the discharge tube, no coating material is coated at an outer side of the first circle, and

a second coating material that has reflectance higher than the second reflectance and higher than the reflectance of the first coating material is coated at an inner side of a second circle of a surface of the rear mirror facing the discharge area, the second circle corresponding to 90% or more and 100% or less of the inner diameter of the discharge tube, no coating material is coated at an outer side of the second circle.

According to a second aspect of the present invention, a laser oscillator, which is the laser oscillator of the first aspect and in which a constituent material of the output coupler includes zinc selenium, is provided.

According to a third aspect of the present invention, a laser oscillator, which is the laser oscillator of the first or second aspect and in which a constituent material of the rear mirror includes germanium single crystal or gallium arsenide, is provided.

According to a fourth aspect of the present invention, a laser oscillator, which is the laser oscillator of any one of the first to third aspects and in which a diameter of the first circle and a diameter of the second circle are equal to each other, is provided.

According to a fifth aspect of the present invention, a laser oscillator, which is the laser oscillator of any one of the first to fourth aspects and in which an anti-reflective coating material that has a diameter equal to a diameter of the first coating material is coated on a surface of the output coupler opposite to the discharge area, and reflectance of the anti-reflective coating material is lower than the first reflectance, is provided.

These objects, features, and advantages of the present invention and other objects, features, and advantages will be better understood from the following detailed description of an exemplary embodiment of the present invention illustrated in the accompanying drawings.

### BRIEF DESCRIPTION OF DRAWINGS

FIG. 1 is a diagram illustrating an entire configuration of a laser oscillator according to an embodiment of the present invention;

FIG. 2 is a front view of a first surface of an output coupler of FIG. 1;

FIG. 3 is a front view of a first surface of a rear mirror of FIG. 1; and

FIG. 4 is a sectional view of main elements of an output coupler constituting a laser oscillator which is a modification of the present invention.

### DETAILED DESCRIPTION OF EMBODIMENT

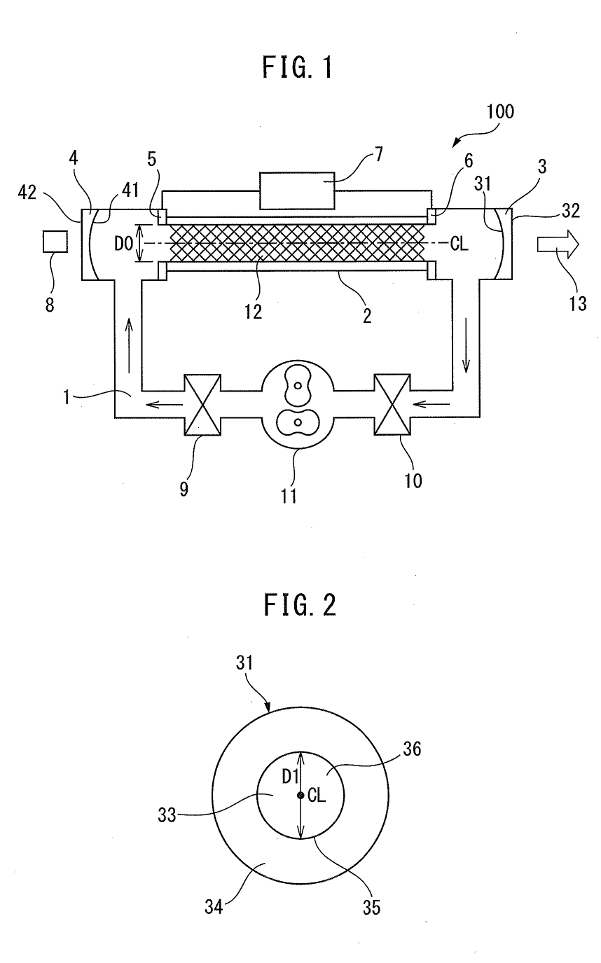

Hereinafter, with reference to FIG. 1 to FIG. 4, an embodiment of a laser oscillator 100 according to the present invention will be described. FIG. 1 is a diagram illustrating an entire configuration of the laser oscillator 100 according to an embodiment of the present invention. The laser oscillator 100 according to the present embodiment is a high output carbon dioxide laser oscillator that employs laser gas as a medium and excites the laser gas by a discharge tube.

As illustrated in FIG. 1, the laser oscillator 100 comprises a gas passage 1 through which laser gas circulates, a discharge tube 2 that communicates with the gas passage 1, an output coupler 3 and a rear mirror 4 that are arranged on both sides of the discharge tube 2 so as to interpose the discharge tube 2 therebetween, a power supply unit 7 that applies a voltage (a discharge tube voltage) to electrodes 5 and 6 of the discharge tube 2, a sensor 8 that detects laser output, heat exchangers 9 and 10 that cool the laser gas, and a blower 11 that circulates the laser gas along the gas passage 1 as indicated by an arrow.

The discharge tube 2 has a cylindrical shape around an axial line CL of a longitudinal direction, which passes through the center of the discharge tube 2, and has a discharge area 12 in the discharge tube 2. The outer peripheral surfaces of the output coupler 3 and the rear mirror 4 respectively have a cylindrical shape around the axial line CL, and outer diameters of the output coupler 3 and the rear mirror 4 are larger than an inner diameter D0 of the discharge tube 2. The output coupler 3 has a first surface 31 facing the discharge area 12 and a second surface 32 opposite to the first surface 31. The rear mirror 4 has a first surface 41 facing the discharge area and a second surface 42 opposite to the first surface 41. Each of the first surface 31 of the output coupler 3 and the first surface 41 of the rear mirror 4 is formed in a concave shape and has a predetermined curvature radius. The second surface 32 of the output coupler 3 is a convex surface having a predetermined curvature radius or a flat surface. The second surface 42 of the rear mirror 4 is a flat surface.

In such a laser oscillator 100, when electric power is supplied to each of the electrodes 5 and 6 of the discharge tube 2, i.e. when the discharge tube voltage is applied, discharge of laser gas is started in the discharge area 12 of the discharge tube 2. By this discharge start, the laser gas is excited to generate light, and resonance occurs between the output coupler 3 and the rear mirror 4, so that the light is amplified by stimulated emission and a part of the amplified light is taken out from the output coupler 3 as laser beam 13. The taken-out laser beam 13 is output from, for example, a laser processing machine and performs cutting of a work.

In this case, the degree of beam quality (light harvesting property) of the laser beam 13 has an influence on the cutting capacity and cutting quality of the work. In case the beam quality is low, if the laser beam has been collected in a processing condensing lens, a condensing diameter is not sufficiently small, stable processing with a short Rayleigh length is not possible and the like, resulting in the deterioration of cutting capacity and instability of cutting capacity.

In order to improve beam quality, it is effective to employ a configuration of restraining laser oscillation of a high order mode and perform laser oscillation only in a lower order mode. In this regard, for example, in the case of employing a configuration of arranging an aperture between the output coupler 3 and the rear mirror 4 and limiting a diameter of laser beam by the aperture, the number of parts increases to complicate the configuration and the aperture absorbs laser beam, resulting in the reduction of laser output. On the other hand, in the case of employing a configuration in which a semi-transmissive film is coated on a radial center portion of the first surface 31 of the output coupler 3 and a non-reflective film is coated at a peripheral portion of the radial center portion, two types of coating with different reflectances are performed, so that a manufacturing process is complicated. Therefore, in the present embodiment, in order to improve beam quality without complicating the manufacturing process, the output coupler 3 and the rear mirror 4 are configured as described below.

FIG. 2 is a front view of the first surface 31 of the output coupler 3 according to the present embodiment. The output coupler 3 is made of a material with low laser absorptance. As an example, zinc selenium (ZnSe) can be preferably used as a constituent material of the output coupler 3. Reflectance α0 of the output coupler 3 made of the zinc selenium is about 20% (20% R) with respect to laser beam having a wavelength of 10.6 μm.

The first surface 31 of the output coupler 3 is divided into a first area 33 inside a circle 35 and a second area 34 having a ring shape outside the circle 35 by employing the circle 35 around the axial line CL as a boundary. A diameter D1 of the circle 35 serving as the boundary between the first area 33 and the second area 34, for example, is 90% to 100% of an inner diameter D0 of the discharge tube 2. On the first area 33, a first coating material 36 having predetermined reflectance α1 is coated. The first coating material 36, for example, is stacked on the first area 33 as a dielectric multilayer. On the second area 34, since no coating material is coated, reflectance of the second area 34 has a value decided by a material of the output coupler 3, i.e. α0.

The first coating material 36 has the reflectance α1 appropriate for laser oscillation. The reflectance α1 is selected from the range of 40% to 70% (40% R to 70% R) according to the configuration of the laser oscillator 100, and is higher than the reflectance α0 of the second area 34. For example, when the number of discharge tubes 2 is large, the entire length of the discharge tube 2 is long, medium density is high, a resonator length is long and the like, since a gain becomes large, the first coating material 36 that has small reflectance α1 (for example, 40%) is used. On the other hand, when the number of discharge tubes 2 is small, the entire length of the discharge tube 2 is short, the medium density is low, the resonator length is short and the like, since a gain becomes small, the first coating material 36 that has large reflectance α1 (for example, 70%) is used.

As described above, the first coating material 36 having the predetermined reflectance α1 (40% to 70%) is stacked, as a dielectric multilayer, at an inner side the first surface 31 of the output coupler 3, which corresponds to 90% to 100% of the inner diameter D0 of the discharge tube 2. In this way, laser oscillation of a high order mode can be suppressed and laser oscillation can occur in a low order mode, so that it is possible to improve beam quality. Furthermore, the output coupler 3 is made of zinc selenium having the reflectance α0 lower than the reflectance α1, and no coating material is coated around the first coating material 36. In this way, since it is sufficient if only one type of coating material is coated on the first surface 31 of the output coupler 3, the manufacturing process becomes easy.

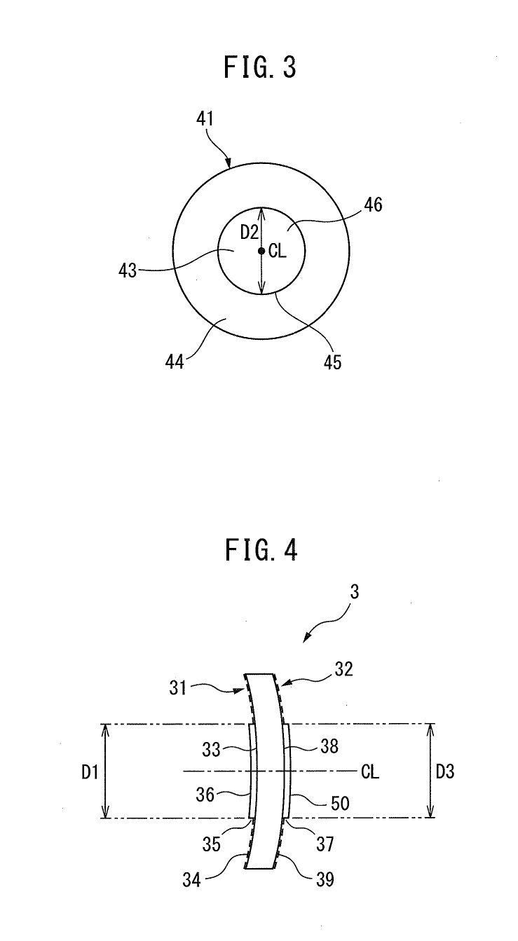

FIG. 3 is a front view of the first surface 41 of the rear mirror 4 according to the present embodiment. The rear mirror 4 is made of a material with a low thermal expansion coefficient with respect to laser absorptance. As an example, germanium single crystal (Ge single crystal) can be preferably used as a constituent material of the rear mirror 4. Reflectance β0 of the rear mirror 4 made of germanium single crystal is about 35% (35% R) with respect to laser beam having a wavelength of 10.6 μm. Instead of the germanium single crystal, gallium arsenide (GaAs) can also be used as a constituent material of the rear mirror 4.

The first surface 41 of the rear mirror 4 is divided into a first area 43 inside a circle 45 and a second area 44 having a ring shape outside the circle 45 by employing the circle 45 around the axial line CL as a boundary. A diameter D2 of the circle 45 serving as the boundary between the first area 43 and the second area 44, for example, is 90% to 100% of the inner diameter D0 of the discharge tube 2. The diameter D2 is preferably equal to the diameter D1 of the circle 35 of the first surface 31 of the output coupler 3.

On the first area 43, a second coating material 46 that has predetermined reflectance β1 is coated. On the second area 44, no coating material is coated. Reflectance of the second area 44 has a value decided by a material of the rear mirror 4, i.e. β0. The second coating material 46 is a total reflective coating material. The reflectance β1 thereof, for example, is 90% or more, preferably, 99% or more, and is higher than the reflectance β0 of the second area 44 and higher than the reflectance α1 of the first coating material 36.

As described above, high reflective coating is performed at an inner side of the first surface 41 of the rear mirror 4, which corresponds to 90% to 100% of the inner diameter D0 of the discharge tube 2, by using the second coating material 46 having the predetermined reflectance β1. In this way, laser oscillation of a high order mode can be suppressed and oscillation efficiency of a low order mode can be improved. Furthermore, the rear mirror 4 is made of germanium single crystal or gallium arsenide having the reflectance β0 lower than the reflectance β1, and no coating material is coated around the first coating material 46. In this way, since it is sufficient if only one type of coating material is coated on the first surface 41 of the rear mirror 4, the manufacturing process becomes easy.

According to the aforementioned embodiment, the following operations and effects can be obtained.

(1) The laser oscillator 100 is configured such that while the first coating material 36 having the reflectance α1 higher than the first reflectance α0 of the constituent material of the output coupler 3 is coated at an inner side of the circle 35 of the first surface 31 of the output coupler 3, which corresponds to 90% or more and 100% or less of the inner diameter D0 of the discharge tube 2, no coating material is coated on an outer side of the circle 35, and while the second coating material 46 having the reflectance β1 higher than the second reflectance β0 of the constituent material of the rear mirror 4 and higher than the first reflectance α1 of the first coating material 36 is coated at an inner side of the circle 45 of the first surface 41 of the rear mirror 4, which corresponds to 90% or more and 100% or less of the inner diameter D0 of the discharge tube 2, no coating material is coated on an outer side of the circle 45. In this way, laser oscillation can occur only in the center portions of the output coupler 3 and the rear mirror 4 subjected to the coating process. Consequently, a high order mode is suppressed, so that it is possible to improve beam quality by a simple configuration using no aperture. Furthermore, one type of coating material is coated on each of the output coupler 3 and the rear mirror 4, so that it is possible to easily perform the coating process at low cost.

Moreover, the boundary line between the first area 33 and the second area 34 of the output coupler 3 is set on the circle 35 around the axial line CL of the discharge tube 2, the diameter D1 of the circle 35 is set to be 90% or more and 100% or less of the inner diameter D0 of the discharge tube 2, the boundary line between the first area 43 and the second area 44 of the rear mirror 4 is set on the circle 45 around the axial line CL of the discharge tube 2, and the diameter D2 of the circle 45 is set to be 90% or more and 100% or less of the inner diameter D0 of the discharge tube 2. In this way, it is possible to improve balance of beam quality and laser output. On the other hand, for example, when the diameters D1 and D2 of the boundary lines (the circles 35 and 45) become less than 90% of the inner diameter D0 of the discharge tube 2, since a high order mode component of laser beam may not oscillate, beam quality is improved. However, since loss of laser output becomes large, reduction of the output of laser beam becomes problematic.

(2) As a constituent material of the output coupler 3, zinc selenium, which is a material with low laser absorptance, is used; therefore it is possible to suppress thermal lens effect and to improve beam quality.

(3) As a constituent material of the rear mirror 4, germanium single crystal or gallium arsenide, which is a material with a low thermal expansion coefficient, is used; therefore it is possible to improve beam quality.

(4) If the diameter D1 of the outer peripheral circle 35 of the first coating material 36 of the output coupler 3 and the diameter D2 of the outer peripheral circle 45 of the second coating material 46 of the rear mirror 4 are set to be equal to each other, it is possible to effectively improve both beam quality and laser output.

In addition, in the aforementioned embodiment, the first coating material 36 is coated on the first surface 31 of the output coupler 3; however, in addition to this, a separate coating material may also be coated on the second surface 32 of the output coupler 3. FIG. 4 is a sectional view of the output coupler 3 illustrating such an example. In FIG. 4, the second surface 32 of the output coupler 3 is partitioned into a first area 38 inside a circle 37 and a second area 39 outside the circle 37 by employing the circle 37 around the axial line CL as a boundary. On the first area 38, an anti-reflective coating material 50 is coated, and the second area 39 is not subjected to a coating process.

An outer diameter D3 of the circle 37 of the anti-reflective coating material 50 is equal to the outer diameter D1 of the circle 35 of the first coating material 36. Moreover, the first coating material 36 and the anti-reflective coating material 50 are respectively coated on the same areas of the first surface 31 and the second surface 32 of the output coupler 3. Since reflectance of the anti-reflective coating material 50 is zero or almost zero, reflectance of the first area 38 is lower than that of the second area 39.

As described above, on the second surface 32 of the output coupler 3, the anti-reflective coating material 50 having the diameter D3 equal to that of the first coating material 36 is coated; therefore it is possible to efficiently output laser beam of a low order mode having passed through the first coating material 36 to an exterior of the laser oscillator 100. Furthermore, since the second area 39 of the second surface 32 of the output coupler 3 is not coated with an anti-reflective coating material, a high order mode component that has passed through the second area 34 of the first surface 31 is reflected in the second area 39 of the second surface 32. Consequently, it is possible to prevent laser beam of a high order mode from being emitted to an exterior of the laser oscillator 100, resulting in the improvement of beam quality.

In this case, since carbon dioxide laser for work cutting is high output laser exceeding 1 kw, the high order mode component reflected in the second area 39 and returned to the discharge area 12 may perform laser oscillation. However, since it is output ignorable when the high order mode component is compared with the low order mode component oscillating in the first area 33, it does not contribute to a cutting process. In addition, when the anti-reflective coating material 50 that has the diameter D3 (=D1) equal to that of the first coating material 36 is coated on a surface (the second surface 32) of the output coupler 3 opposite to the discharge area 12 and the reflectance of the anti-reflective coating material 50 is lower than the first reflectance β0, various anti-reflective coating materials can be used.

In addition, in the aforementioned embodiment, the single discharge tube 2 is provided in the laser oscillator 100 (FIG. 1); however, a plurality of discharge tubes 2 may also be provided. The arrangements and configurations of the output coupler 3 and the rear mirror 4 are not limited to the aforementioned arrangements and configurations if they are arranged at both sides of the discharge tube 2. For example, at least one of the first surface 31 of the output coupler 3 and the first surface 41 of the rear mirror 4 may be formed to be flat other than a concave shape. In the aforementioned embodiment, as a constituent material of the output coupler 3, zinc selenium with low laser absorptance is used, and as a constituent material of the rear mirror 4, germanium single crystal or gallium arsenide with low thermal expansion is used; however, the constituent materials of the output coupler 3 and the rear mirror 4 are not limited thereto.

If the first coating material 36 that has the reflectance α1 higher than the first reflectance α0, i.e. the reflectance α1 appropriate for a laser oscillator, is coated at an inner side of the circle 35 (a first circle) of the surface (the first surface 31) of the output coupler 3 facing the discharge area 12, the circle 35 corresponding to 90% or more and 100% or less of the inner diameter of the discharge tube 2, there is no any limitation in the configuration of a first coating material to be coated on the first surface 31. Furthermore, if the second coating material 46 that has the reflectance β1 higher than the second reflectance β0 and higher than the reflectance α1 of the first coating material 36 is coated at an inner side of the circle 45 (a second circle) of the surface (the first surface 41) of the rear mirror 4 facing the discharge area 12, the circle 45 corresponding to 90% or more and 100% or less of the inner diameter of the discharge tube 2, there is no any limitation in the configuration of a second coating material to be coated on the first surface 41.

According to the present invention, the first coating material and the second coating material are respectively coated at the inner side of the first circle of the surface of the output coupler and the inner side of the second circle of the surface of the rear mirror, and no coating material is coated at an outer side of the first circle and an outer side of the second circle. Consequently, oscillation of a high order mode is suppressed; therefore it is possible to improve beam quality by a simple configuration using no aperture. Furthermore, one type of coating material is coated on each of the output coupler and the rear mirror; therefore it is possible to easily perform the coating process at low cost.

The above description is merely an example, and the present invention is not limited to the aforementioned embodiments and modifications as long as they do not impair the features of the present invention. Elements of the embodiments and the modifications include elements which can be replaced and are apparently replaced while maintaining the identification of the present invention. In other words, other embodiments considered within the technical scope of the present invention are included in the scope of the present invention. In addition, two or more of the embodiments and the modifications can also be arbitrarily combined.

What is claimed is:

1. A laser oscillator comprising:
a discharge tube including a discharge area in which laser gas is excited and an output coupler; and
a rear mirror respectively arranged at both sides of the discharge tube,
wherein the output coupler and the rear mirror are made of materials having first reflectance and second reflectance with respect to laser beam,
a first coating material that has reflectance higher than the first reflectance is coated at an inner side of a first circle of a surface of the output coupler facing the discharge area, the first circle corresponding to 90% or more and 100% or less of an inner diameter of the discharge tube, and no coating material is coated at an outer side of the first circle, and
a second coating material that has reflectance higher than the second reflectance and higher than the reflectance of the first coating material is coated at an inner side of a second circle of a surface of the rear mirror facing the discharge area, the second circle corresponding to 90% or more and 100% or less of the inner diameter of the discharge tube, and no coating material is coated at an outer side of the second circle.

2. The laser oscillator according to claim 1, wherein a constituent material of the output coupler comprises zinc selenium.

3. The laser oscillator according to claim 1, wherein a constituent material of the rear mirror comprises germanium single crystal or gallium arsenide.

4. The laser oscillator according to claim 1, wherein a diameter of the first circle and a diameter of the second circle are equal to each other.

5. The laser oscillator according to claim 1, wherein an anti-reflective coating material that has a diameter equal to a diameter of the first coating material is coated on a surface of the output coupler opposite to the discharge area, and reflectance of the anti-reflective coating material is lower than the first reflectance.
